(19) United States
(12) Patent Application Publication
(10) Pub. No.: US 2017/0199870 A1
(43) Pub. Date: Jul. 13, 2017

(54) Method and Apparatus for Automatic Translation of Input Characters

(71) Applicant: Beijing Xinmei Hutong Technology Co.,Ltd, Beijing (CN)

(72) Inventors: Sheng ZHENG, Beijing (CN); Meng WANG, Beijing (CN)

(73) Assignee: Beijing Xinmei Hutong Technology Co.,Ltd

(21) Appl. No.: 15/157,323

(22) Filed: May 17, 2016

(30) Foreign Application Priority Data
Jan. 13, 2016 (CN) 201610022169.6

(51) Int. Cl. G06F 17/28; G06F 17/22; G06F 17/27

(52) U.S. Cl. CPC G06F 17/2836; G06F 17/275; G06F 17/2223

(57) ABSTRACT

Disclosed herein is a method for an automatic translation of input characters in the field of information input, which solves the low-efficiency problem in existing technologies for translating input characters. This method comprises: obtaining a translation command to translate characters entered in a first language; based on the language setting of the input interface for receiving first language input characters, determining a second language; and translating the characters entered in the first language into corresponding characters in the second language. By automatically determining the target language based on the input interface for receiving first language characters, the present invention allows for a rapid translation of input characters, a reduction in user operations, enhanced translation efficiency and improved user experiences.

### FIELD OF THE INVENTION

The present invention generally relates to the filed of information input technologies, and in particular, a method and apparatus for an automatic translation of input characters.

### BACKGROUND

As the world has been increasingly integrated today, cross-border and cross-language communications and information exchange have become very frequent. However, people having different native languages will be faced with language barriers and may have to rely on certain translation software in such communications. For example, they may need to type words or phrases in one language (e.g., native language) in order for the translation software to translate them into another language (e.g., target or foreign language) or vice versa.

In the field of information input technologies, e.g., receiving input characters via the real-time mobile communication software, translation of input characters can be simplified by allowing a user to first select the content to be translated, take an action such as “long press” so that a drop-down menu including various target languages is displayed, select one language from the drop-down menu, and then click the “translate” button so that the selected content is translated into the selected target language.

However, existing technologies for translating input characters during the information input process have the following deficiencies: for lack of the real-time translation capability, a user needs to perform multiple actions in order to receive the translation result, thereby resulting in low translation efficiency and unfriendly user experiences.

### SUMMARY OF THE INVENTION

The presently disclosed embodiments are directed to solving issues relating to one or more of the problems presented in the prior art, as well as providing additional features that will become readily apparent by reference to the following detailed description when taken in conjunction with the accompanying drawings.

One objective of the present invention is to provide a method of automatic translation of input characters, which is designed to solve the following technical problems with existing technologies: low translation efficiency and lack of real-time translation.

In order to solve the above-stated problems, one embodiment of the invention provides a method of automatic translation of input characters, comprising: obtaining a translation command for translating characters entered in a first language; based on a language setting of an input interface for receiving first language input characters, determining a second language; and translating the characters entered in the first language into corresponding characters in the second language.

In one embodiment, the method further comprises providing an output of the corresponding characters in the second language after translating the characters entered in the first language into corresponding characters in the second language.

In another embodiment, the method further comprises providing an output of both the corresponding characters in the second language and the characters entered in the first language after translating the characters entered in the first language into corresponding characters in the second language.

Further, according to one embodiment of the invention, the translation command comprises a command triggered by a pre-defined key, or a command instructing a user input or deletion of first language characters, or a command for a manual selection of first language characters for translation.

In one embodiment, the method further comprises determining a language type for displaying characters in the input interface for receiving the first language input characters, the input interface positioned in a communication page; and using the determined language type as the second language.

Further, the language type for displaying characters in the input interface for receiving the first language input characters is determined by: obtaining one or more machine codes of characters displayed in the communication page; and applying a Maximum Likelihood Estimate (MLE) to determine a language type that has the largest probability, wherein said language type is used for displaying characters in the input interface for receiving the first language input characters.

In one embodiment, the language type for displaying characters in the input interface for receiving the first language input characters is determined by: obtaining one or more attributes of the communication page; identifying a language from the obtained attributes; and using the identified language as the language type for displaying characters in the input interface for receiving the first language input characters.

In an alternative embodiment, the language type for displaying characters in the input interface for receiving the first language input characters is determined by: using a previously-used second language based on translation records or a user-defined target language as the language type for displaying characters in the input interface for receiving the first language input characters.

Embodiments of the invention also provide an apparatus for an automatic translation of input characters, comprising: a translation command module for obtaining a translation command for translating characters entered in a first language; a target language determination module for determining a second language based on a language setting of an input interface for receiving first language input characters; and a translation module for translating the characters entered in the first language into corresponding characters in the second language.

In one embodiment, the apparatus further comprises a first output module for providing an output of the corresponding characters in the second language.

In another embodiment, the apparatus further comprises a second output module for providing an output of both the corresponding characters in the second language and the characters entered in the first language.

In one embodiment, the translation command comprises a command triggered by a pre-defined key, or a command instructing a user input or deletion of first language characters, or a command for a manual selection of first language characters for translation.

In one embodiment, the apparatus further comprises a language setting determination sub-module for determining a language type for displaying characters in the input interface for receiving the first language input characters, the input interface positioned in a communication page; and a target language determination sub-module for using the determined language type as the second language.

Further, the language setting determination sub-module is configured for obtaining one or more machine codes of characters displayed in the communication page; and applying a Maximum Likelihood Estimate (MLE) to determine a language type that has the largest probability, wherein said language type is used for displaying characters in the input interface for receiving the first language input characters.

In one embodiment, the language setting determination sub-module is configured for obtaining one or more attributes of the communication page; identifying a language from the obtained attributes; and using the identified language as the language type for displaying characters in the input interface for receiving the first language input characters.

In another embodiment, the language setting determination sub-module is configured for using a previously-used second language based on translation records or a user-defined target language as the language type for displaying characters in the input interface for receiving the first language input characters.

By performing the above-stated steps of obtaining a translation command to translate one or more characters entered in a first language, determining a second language based on the input interface of the characters entered in the first language, and translating the characters entered in the first language into corresponding characters in the second language, embodiments of the present invention allow for a rapid translation of input characters, thereby reducing user operations and improving the translation efficiency as well as user experiences.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is a flow diagram showing a method for automatic translation of input characters according to one embodiment of the present invention;

FIG. 2 is a flow diagram showing a method for automatic translation of input characters according to another embodiment of the present invention;

FIG. 3 is a flow diagram showing a method for automatic translation of input characters according to yet another embodiment of the present invention;

FIG. 4 is a flow diagram illustrating an input interface for a first language according to one embodiment of the present invention;

FIG. 5 is a flow diagram illustrating an input interface for a first language according to another embodiment of the present invention;

FIG. 6 is a block diagram illustrating various modules of an apparatus for automatic translation of input characters according to one embodiment of the present invention;

FIG. 7 is a block diagram illustrating various modules of an apparatus for automatic translation of input characters according to another embodiment of the present invention; and

FIG. 8 is a block diagram illustrating various modules of an apparatus for automatic translation of input characters according to yet another embodiment of the present invention.

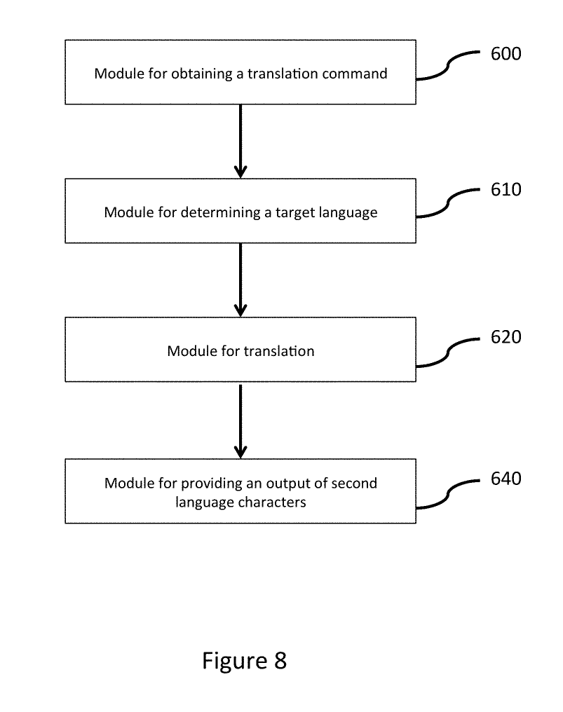

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, embodiments of the present invention are not intended to be limited to the examples described herein and shown, but is to be accorded the scope consistent with the claims.

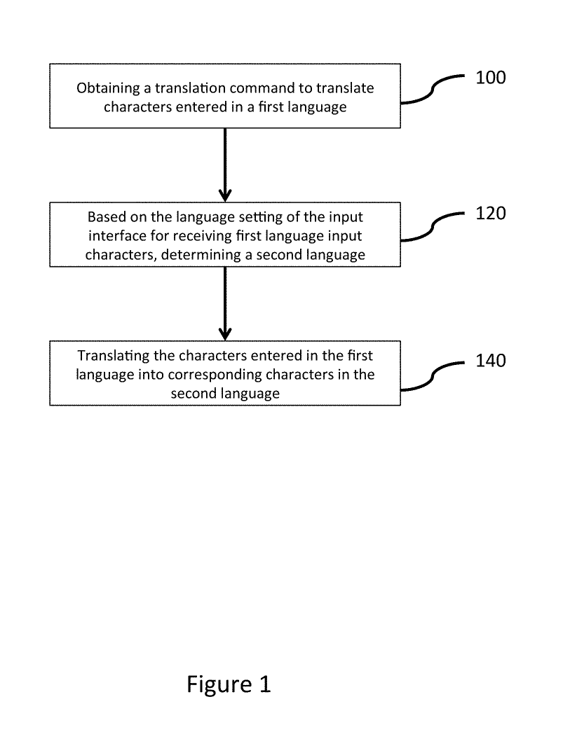

As shown in FIG. 1, a method for an automatic translation of input characters according to one embodiment of the present invention comprises the following steps:

Step 100, obtaining a translation command to translate characters entered in a first language;

Step 120, determining a second language based on the input interface for receiving first language input characters;

Step 140, translating the characters entered in the first language into corresponding characters in the second language.

By performing the above-stated steps of obtaining a translation command to translate one or more characters entered in a first language, determining a second language based on the input interface of the characters entered in the first language, and translating the characters entered in the first language into corresponding characters in the second language, the present invention allows for a rapid translation of input characters, thereby reducing user operations and improving the translation efficiency as well as user experiences.

There are a number of different application scenarios and input manners for receiving input characters. Many of these scenarios require a user input of characters, for example, a user needs to type up text messages in some real-time communications software; users need to enter keyword when searching for information on the Internet, or provide and input of location information in a GPS software, or edit the text of an email, and so forth. In terms of how to provide the input, there are various ways, including keyboard input, manual input and voice input. Usually once an input device detects a user input, it converts the obtained user input into corresponding characters, which are to be received as input characters. For example, a touch panel collects a user's touch input, determines the machine codes of characters corresponding to the touch input, and receives such characters as input characters. Voice input is usually obtained via a microphone device that collects a user's voice data, and a sound collection module that processes the user's voice data to generate the machine codes of characters corresponding to the voice input, which characters will be received as the input characters. In the case of receiving a user input of characters, the characters are initially entered in a first language or local language. For example, in the real-time communications software, if the first language is Chinese, then the user is provided with a Chinese handwriting interface or a voice interface recognizing a Chinese input or a pinyin keyboard receiving Chinese characters. In one configuration, the input characters are embodied in the machine codes of corresponding characters in the first language. In the above Step 100, depending on the specific application scenarios or input manners for receiving input characters, the translation commands can vary a lot. The translation command for translating the characters entered in the first language can be set based on different application scenarios. In operation, the translation command for translating the characters entered in the first language can include: a command triggered by one or more pre-defined keys; or a command instructing a user to enter or delete a first language character; or a command for a manual selection of characters for translation. In one embodiment, the pre-defined keys can be physical keys or virtual keys or both based on their input states, or special translation keys or common keys or both based on their input functions. Take the real-time communication software as an example: after characters of a text message are entered in the first language, the text entry can trigger the pre-defined “translate” key to activate translation. Alternatively, after characters of a text message are entered in the first language, the user may click a “enter” or “send” button, and thus, clicking these keys can be set as triggers for translation. For example, if a user enters a search keyword in a web page, the characters entered by the user in the search bar may be combined with existing characters in the search bar to form a new keyword to activate another keyword search. In this case, when the user finishes entering the characters, translation can be automatically activated through the following process: the input method generates a command to receive input characters in the search bar, which command can also act as a command to activate translation of the characters. In the case of receiving input characters in text editing, the translation command can be activated upon detecting a user input of the first character entered in the first language, or upon a user selection of one or more characters via the mouse or touch panel, or upon detecting the completion of a user input of the first unit of characters entered in the first language. For instance, if the first language is Chinese, when the currently entered character is detected to have a machine code of 3002, i.e., the machine code for “°”, then it should be determined that one sentence entry is complete, upon which translation should be activated automatically.

According to embodiments of the invention, the translation command for translating characters entered in the first language can be pre-set as an automatic command, such as the “send” command, and as a result, user operations are reduced, translation efficiency is improved, and user experiences are enhanced. In addition, real-time translation of input characters is accomplished.

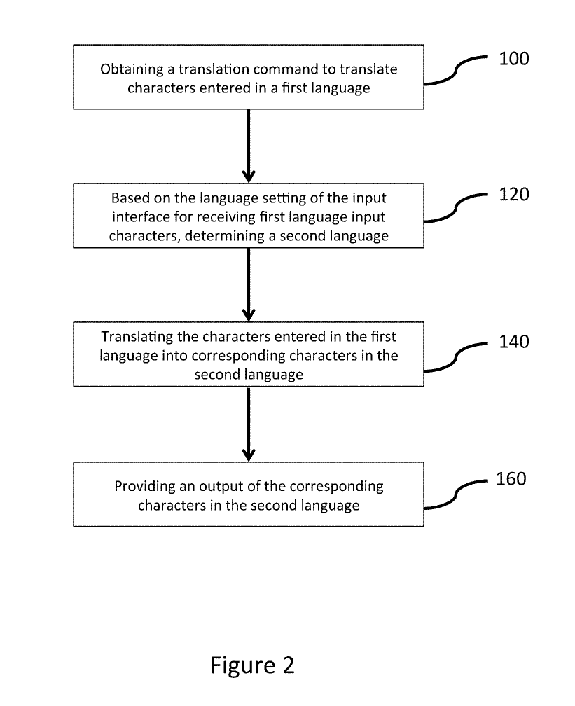

According to one embodiment of the invention, as illustrated in FIG. 2, this method for an automatic translation of input characters includes an additional step as follows:

Step 160, providing an output of the corresponding characters in the second language.

After the characters entered in the first language are translated into corresponding characters in the second language, the corresponding characters are displayed. This is because the second language is determined by the language setting of the input interface for receiving the first language input characters, which is based on the user preference for reading and writing purposes. In the case of receiving information input in the real-time communications software, once it is determined that the second language is English based on either the chatting records or text messages already sent to the chatting page, and a user enters Chinese characters and clicks “send,” the entered Chinese characters will be translated into corresponding English characters according to the above-described Step 140. Thereafter, in Step 160, the translated English characters will be sent to the chatting page or text-editing box for display. Upon further commands, the translated English characters can also be sent to the other client terminal in the chatting group.

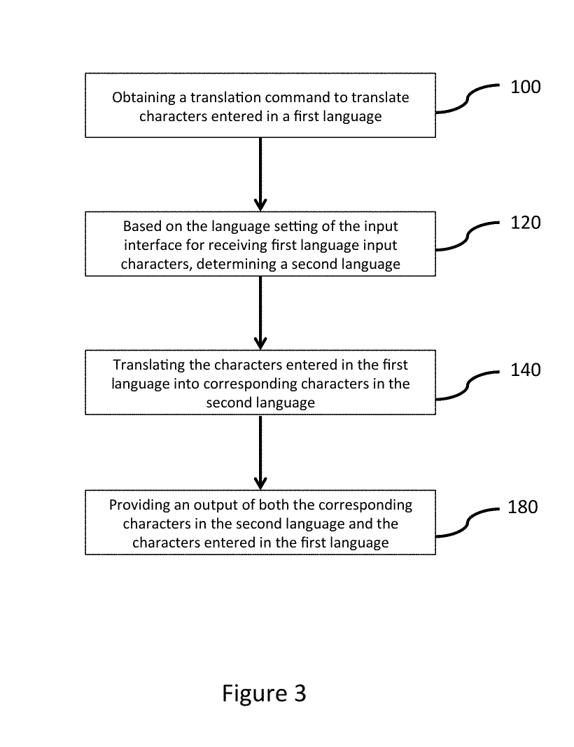

Preferably, in another embodiment of the present invention, as shown in FIG. 3, this method for an automatic translation of input characters further comprise the following step:

Step 180, providing an output of both the corresponding characters in the second language and the entered characters in the first language. In order for the user who entered characters to view his or her own input characters, one embodiment of the present invention allows for an output of both the corresponding characters in the second language and the entered characters in the first language after the first language characters are translated into the second language characters. Again, using the real-time communications software as an example, when the user enters Chinese characters, if the second language is English, the entered Chinese characters will be translated into corresponding English characters upon the user's click of “send” button, according to the above-mentioned Step 140. Thereafter, in Step 180, both the entered Chinese characters and translated English characters will be sent to the chatting page or text-editing box for display. Upon further commands, both the entered Chinese characters and the translated English characters can also be sent to the other client terminal in the chatting group.

In operation, the second language is not limited to one. Using the real-time communication software as an example, if the user of the current client terminal is using Chinese to chat with one terminal using English and one using French, then in Step 140, the user-entered Chinese characters are translated into corresponding characters in English and French, respectively. Then, in Step 180, both the entered Chinese characters and translated English and French characters will be sent to the chatting page or text-editing box for display.

In the above-described embodiments, the first language used by the current client terminal can be determined from the way the input characters are received, or the real-time communications software, or a certain interface of the web browser. As for the second language, it can be determined from the language settings of the input interface for receiving first language input characters. Specifically, the second language is determined from the language setting of the input interface for receiving first language characters via the following process: first, determining the type of language for characters displayed in the input interface for receiving the first language input characters; then, using the determined type of language as the second language. In order to determine the type of language for characters displayed in the input interface for receiving the first language characters, the following process is performed: first, obtaining the machine codes of the displayed characters in the input interface for receiving the first language characters and determining the type of language based on the machine codes; then applying a Maximum Likelihood Estimate (MLE) to determine the type of language having the largest probability of use, which language type will then be used as the type of language for displayed characters in the input interface. Alternatively, the process can retrieve the attributes of the web page for receiving first language input characters, and from the retrieved attributes, identify the language type for the web page as the type of language for displayed characters. If no such information as the language type for the web page can be obtained, the process can adopt the previously-used second language on the translation records or a user-selected target language as the type of language for the input interface for receiving first language characters.

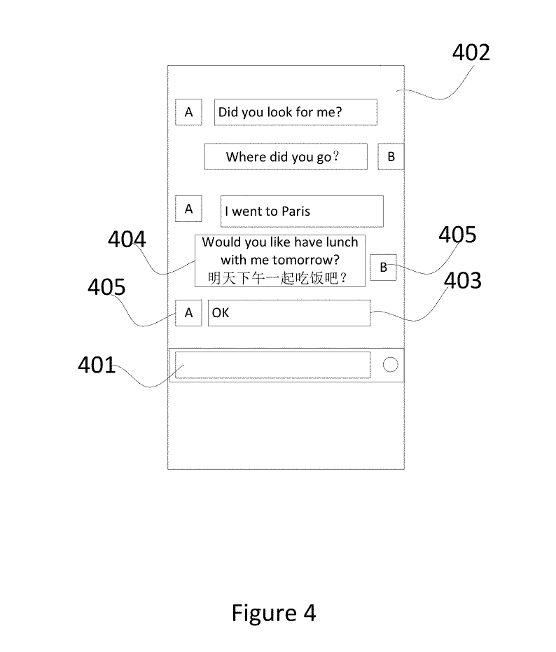

In the case of receiving input characters in some real-time communications software, as shown in FIG. 4, the input interface for receiving first language characters 401 is positioned within the real-time communication page 402, where the first step is to obtain the language type for the characters displayed in the real-time communication page. For example, the displayed characters in the real-time communication page are messages or chatting records, such as messages 403 and 404, which are sent from various client terminals participating in the chatting group. The characters displayed in the real-time communication page 402 can be obtained through the chatting records stored in the real-time communications software, as well as the identifier 405 of the client terminal (e.g., A or B in FIG. 4). In this case, the obtained characters are not limited to the displayed characters in the current screen, but may include all characters displayed in the page 402 within a pre-defined time period, such as chatting records within the most recent 10 days or 100 days, etc. Thereafter, for chatting records sent by the other client terminal, i.e., messages 404, the language type can be determined based on the machine codes of the obtained characters. As a result, the statistics of all language types used in the chatting records can be obtained. Then, based on such statistics, MLE is applied to identify the language type having the largest probability of use as the type of language for displayed characters in the communication page 402. For instance, the local client terminal 403 uses Chinese as input characters, and the other client terminal 404 uses English as input characters. By accessing and retrieving the chatting records stored in the real-time communication software, the most recent 100 chatting records from the other client terminal 404 can be obtained. These chatting records comprise 1000 characters, of which 890 characters are determined to be English and the remaining 110 characters Chinese. Based on such determination, English will be identified as the type of language for the communication page 402.

If a new chatting or dialogue page is first created without any sent messages, or if the chatting records have been deleted, no displayed characters can be obtained from the chatting records in the real-time communications software. In this case, the type of language for characters displayed in the input interface for receiving first language characters can be set as the previously used second language on the translation record, or a user-defined target language. In this embodiment, in Step 140, after the first language characters are translated into corresponding second language characters, the second language will be recorded for later use, for example, to be used for translating the first language input characters next time.

In one embodiment, if there is no way to determine the input language at the other client terminal, based on the previous language setting, a user-selected target language can be used as the second language. For example, the language setting can be as follows: if the second language used by the other client terminal cannot be determined through the chatting records, use the first language as the second language. This means, if the local client terminal uses Chinese to communicate with the other client terminal, before the other terminal sends any messages, the type of language used by the other terminal cannot be determined through the chatting records, in which case, by default, the language used by the other terminal is determined to be Chinese, and thus, the Chinese characters entered in the local terminal will be sent directly to the other terminal without translation. Alternatively, if the second language is pre-set as English, then, by default, the language used by the other terminal is determined to be English, and thus, the Chinese characters entered in the local terminal will be translated into English before sending to the other client terminal.

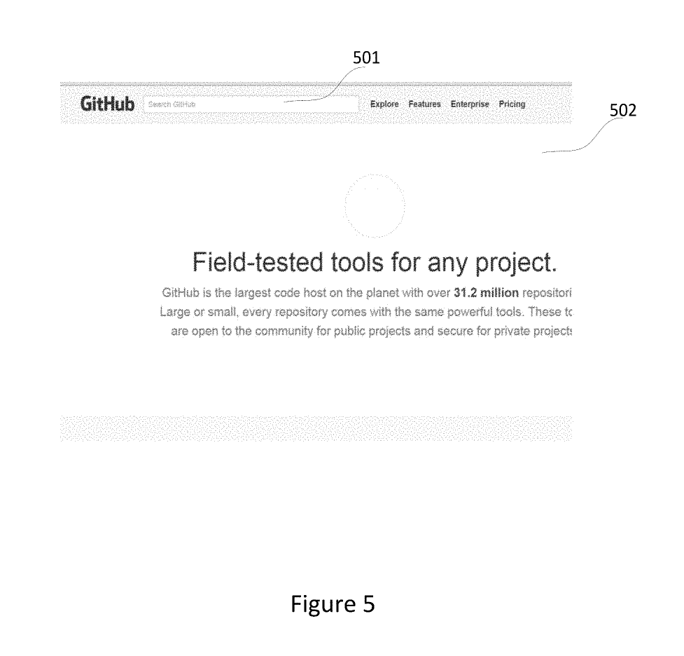

In another embodiment, by obtaining the attributes of the page in which the input interface is positioned for receiving first language characters, the language type for the page can be identified. For example, as shown in FIG. 5, the input interface can be the same as the search bar in the web page, i.e., the input window 501 is within the web page 502. In this case, by accessing and retrieving the web page codes, the web title, link keywords and description text can be obtained. Then, the machine codes for the characters in the text can also be obtained to determine the language type corresponding to the machine codes. Again, MLE is applied to identify the language type having the largest probability of use as the type of language for displayed characters in the page. For example, if the description text is obtained for the web page 502, it includes a total of 55 characters, 98% of which are determined to be English characters, and as a result, English will be considered to be the type of language for displaying characters of the page.

In some implementations, various attributes of the web page can be obtained, including the language type used for the web page 502. For example, if the web page codes include <html lang=“zh-EN”>, it means that the web page is displayed in English, and thus, the language type for the page should be English. Therefore, the characters displayed in the web page 502 should be in English.

There are various ways to translate the first language characters into corresponding second language characters. One example is to correlate different dictionaries to establish the corresponding relationships between the first and second language characters so as to allow for a machine translation. For instance, the word “ [symbol] ” in a Chinese dictionary is correlated to the word “hello” in an English dictionary, the word “bonjour” in a French dictionary, and the word “hola” in a Spanish dictionary. Another way of translation is to leverage the grammatical analysis by which the first language characters can be divided into multiple word units, each of which is translated into corresponding word units in the second language, and such translated word units will be structured into the sent content pursuant to the second language grammars. Many other existing technologies can be used to translate the first language characters into second language characters.

It should be understood that the above-described application scenarios, i.e., receiving input characters in the real-time communications software and receiving a keyword input in a search bar of a web page, are two exemplary scenarios for illustration only, and the present invention is not so limited, but can be applicable in many other scenarios, for example, when a user enters characters in an email or enters a geographical name in a map app. In those cases, the user's first language characters can be translated into second language characters that match the display interface, and the translated second language characters can be displayed in the applicable input box or text-editing interface.

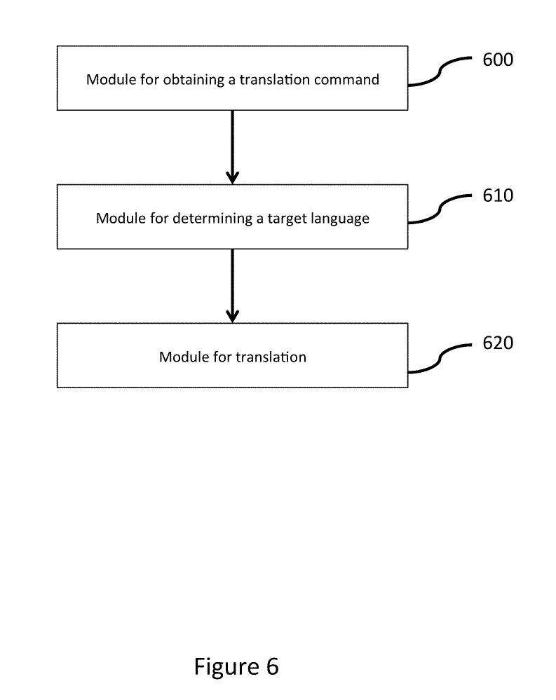

One embodiment of the present invention provides an apparatus for automatic translation of input characters, as demonstrated in FIG. 6. This apparatus comprises:

Module 600 for obtaining the translation command, which is configured for obtaining a translation command for translating the characters entered in the first language;

Module 610 for determining the target language, which is configured to determine the second language based on the language setting of the input interface for receiving first language characters;

Module 620 for translation, which is configured to translate the first language characters into the second language characters.

In operation, the translation command for translating the characters entered in the first language further comprises: a command triggered by a pre-defined key, or a command instructing a user input or deletion of first language characters, or a command requiring a manual selection of characters for translation.

By performing the steps of obtaining a translation command to translate one or more characters entered in a first language, determining a second language based on the input interface of the characters entered in the first language, and translating the characters entered in the first language into corresponding characters in the second language, the present invention allows for a rapid translation of input characters, thereby reducing user operations and improving the translation efficiency as well as user experiences.

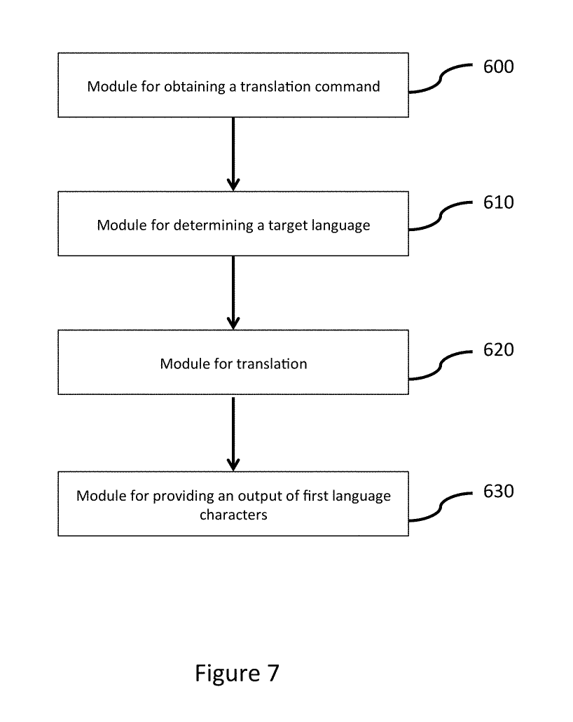

According to anther embodiment of the invention, as shown in FIG. 7, the apparatus further comprises:

Module 630 for providing an output of first language characters, which is configured to provide an output of first language characters. This is because the second language is determined by the language setting of the input interface for receiving the first language input characters, which is based on the user preference for reading and writing purposes. In the case of receiving information input in the real-time communications software, if the second language is English, when a user enters Chinese characters and clicks “send” or a pre-defined translation button, the translation module 620 will translate the entered Chinese characters into corresponding English characters. Thereafter, module 630 will send the translated English characters to the current chatting page or text-editing box for display. Upon further commands, the translated English characters can also be sent to the other client terminal in the chatting group.

According to anther embodiment of the invention, as shown in FIG. 7, the apparatus further comprises:

Module 640 for providing an output of the second language characters, which is configured for providing an output of both corresponding characters in the second language and the entered characters in the first language. In order for the user who entered characters to view his or her own input characters, one embodiment of the present invention allows for an output of both the corresponding characters in the second language and the entered characters in the first language after the first language characters are translated into the second language characters. Again, using the character input in the real-time communications software as an example, when the user enters Chinese characters, if the second language is English, the translation module 620 translates the entered Chinese characters into corresponding English characters upon the user's click of the “send” button or a pre-defined translation button. Thereafter, module 640 sends both the entered Chinese characters and translated English characters the chatting page or text-editing box for display. Upon further commands, both the entered Chinese characters and the translated English characters can also be sent to the other client terminal in the chatting group.

In operation, the second language is not limited to one. Using the real-time communication software as an example, if the user of the current client terminal uses Chinese to chat with one terminal using English and one using French, then module 620 translates the user-entered Chinese characters into corresponding characters in English and French, respectively. Then, module 640 sends both the entered Chinese characters and translated English and French characters to the chatting page or text-editing box for display.

In one embodiment, module 610 for determining the target language further comprises:

a sub-module 6101 for determining the language setting (not shown), which is configured for determining the type of language for displaying characters in the input interface for receiving the first language characters;

a sub-module 6102 for determining the target language (not shown), which is configured for using the determined type of language as the second language.

In operation, depending on specific application scenarios, the sub-module 6101 can be implemented in many different ways. A skilled artisan can come up with various implementations based on the inventive embodiments described herein. For illustration purposes only, below are a few implementation examples.

In one embodiment, the sub-module 6101 for determining the language setting is configured for: obtaining machine codes of the characters displayed in the input interface for receiving first language input characters and determining the type of language corresponding to the machine codes; applying MLE to identify the type of language having the largest probability of use as the language type for displaying characters in the page.

In the case of receiving input characters in the real-time communications software, the input interface for receiving first language characters is positioned within the real-time communication page, where the first step is to obtain the language type for the displayed characters in the real-time communication page. The characters displayed in the real-time communication page are messages, i.e., chatting records, which are sent from various client terminals participating in the chatting group. The characters displayed in the real-time communication page can be obtained through the chatting records stored in the real-time communications software, as well as the identifier from the client terminal. In this case, the obtained characters are not limited to the displayed characters in the current screen, but may include all characters displayed in the page within a pre-set time period, such as chatting records within the most recent 10 days or 100 days, etc. Thereafter, for chatting records sent by the other client terminal, the language type can be determined from the machine codes of the obtained characters. As a result, the statistics of all language types used in the chatting records can be obtained. Then, based on such statistics, MLE is applied to identify the language type having the largest probability of use as the type of language for displayed characters in the communication page. For instance, the local client terminal uses Chinese as input characters, and the other client terminal 404 uses English as input characters. By accessing the chatting records stored in the real-time communication software, the most recent 100 chatting records from the other client terminal can be obtained. These chatting records comprise 1000 characters, of which 890 characters are determined to be English and the remaining 110 characters Chinese. Based on such determination, English will be identified as the type of language for the communication page.

In another embodiment, the sub-module 6101 for determining the language setting is configured for: obtaining various attributes of the web page and using the language type in the obtained attributes as the language for displaying characters in the web page. For example, if the input window is the search bar in a web page where the input window resides, machine codes of the web page can be obtained to determine the attributes of the web page, including the language type used by the web page. For example, if the web page codes include <html lang=“zh-CN”>, it means that the web page is displayed in Chinese, and thus, the language type for the page should be Chinese, i.e., the characters displayed in the page should be in Chinese.

In case the type of language for the input interface for receiving first language characters cannot be determined in any of the previously-mentioned ways, the sub-module 6101 is configured for: using the previously used second language in the translation record or a user-selected target language as the type of language for displaying characters in the input interface for receiving first language characters. If a new chatting or dialogue page is first created without any sent messages, or if the chatting records have been deleted, no displayed characters can be obtained from an access and retrieval to the chatting records in the real-time communications software. In this case, the type of language for displayed characters in the input interface for receiving first language characters can be set as the second language used in the previous translation record, or a user-defined target language. In this embodiment, after the translation module 620 translates the first language characters into corresponding second language characters, the second language will be recorded for later use, for example, to be used for translating the first language input characters next time.

In one embodiment, if there is no way to determine the input language at the other client terminal, the sub-module 6101 is configured for: based on the previous language setting, using a user-selected target language as the second language. For example, the language setting can be as follows: if the second language used by the other client terminal cannot be determined through the chatting records, use the first language as the second language. This means, if the local client terminal uses Chinese to communicate with the other client terminal, before the other terminal sends any messages, the type of language used by the other terminal cannot be determined through the chatting records, in which case, by default, the language used by the other terminal is determined to be Chinese, and thus, the Chinese characters entered in the local terminal will be sent directly to the other terminal without translation. Alternatively, if the second language is pre-set as English, then, by default, the language used by the other terminal is determined to be English, and thus, the Chinese characters entered in the local terminal will be translated into English before sending to the other client terminal.

It should be understood that the above-described case scenarios, i.e., receiving input characters in the real-time communications software and receiving a keyword input in a search bar of a web page, are two exemplary scenarios for illustration only, and the present invention is not so limited, but can be applicable in many other scenarios, for example, when a user enters characters in an email or enters a geographical name in a map app. In these cases, the current user's first language characters can be translated into second language characters that match the display interface, and the translated second language characters can be displayed in the applicable input box or text-editing interface.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

What is claimed is:

1. A method of automatic translation of input characters, comprising:
obtaining a translation command for translating characters entered in a first language;
based on a language setting of an input interface for receiving first language input characters, determining a second language; and
translating the characters entered in the first language into corresponding characters in the second language.

2. The method of claim 1, further comprising:
providing an output of the corresponding characters in the second language after translating the characters entered in the first language into corresponding characters in the second language.

3. The method of claim 1, further comprising:
providing an output of both the corresponding characters in the second language and the characters entered in the first language after translating the characters entered in the first language into corresponding characters in the second language.

4. The method of claim 1, wherein the translation command comprises a command triggered by a pre-defined key, or a command instructing a user input or deletion of first language characters or a command for a manual selection of first language characters for translation.

5. The method of claim 2, wherein the translation command comprises a command triggered by a pre-defined key, or a command instructing a user input or deletion of first language characters or a command for a manual selection of first language characters for translation.

6. The method of claim 3, wherein the translation command comprises a command triggered by a pre-defined key, or a command instructing a user input or deletion of first language characters or a command for a manual selection of first language characters for translation.

7. The method of claim 4, further comprising:
determining a language type for displaying characters in the input interface for receiving the first language input characters, the input interface positioned in a communication page; and
using the determined language type as the second language.

8. The method of claim 7, wherein the language type for displaying characters in the input interface for receiving the first language input characters is determined by:
obtaining one or more machine codes of characters displayed in the communication page; and
applying a Maximum Likelihood Estimate (MLE) to determine a language type that has the largest probability of use, wherein said language type is used for displaying characters in the input interface for receiving the first language input characters.

9. The method of claim 7, wherein the language type for displaying characters in the input interface for receiving the first language input characters is determined by:
obtaining one or more attributes of the communication page;
identifying a language from the obtained attributes; and
using the identified language as the language type for displaying characters in the input interface for receiving the first language input characters.

10. The method of claim 7, wherein the language type for displaying characters in the input interface for receiving the first language input characters is determined by:
using a previously-used second language based on translation records or a user-defined target language as the language type for displaying characters in the input interface for receiving the first language input characters.

11. A apparatus for an automatic translation of input characters, comprising:
a translation command module for obtaining a translation command for translating characters entered in a first language;
a target language determination module for determining a second language based on a language setting of an input interface for receiving first language input characters; and
a translation module for translating the characters entered in the first language into corresponding characters in the second language.

12. The apparatus of claim 11, further comprising:
a first output module for providing an output of the corresponding characters in the second language.

13. The apparatus of claim 11, further comprising:
a second output module for providing an output of both the corresponding characters in the second language and the characters entered in the first language.

14. The apparatus of claim 11, wherein the translation command comprises a command triggered by a pre-defined key, or a command instructing a user input or deletion of first language characters or a command for a manual selection of first language characters for translation.

15. The apparatus of claim 12, wherein the translation command comprises a command triggered by a pre-defined key, or a command instructing a user input or deletion of first language characters or a command for a manual selection of first language characters for translation.

16. The apparatus of claim 13, wherein the translation command comprises a command triggered by a pre-defined key, or a command instructing a user input or deletion of first language characters or a command for a manual selection of first language characters for translation.

17. The apparatus of claim 14, further comprising:
a language setting determination sub-module for determining a language type for displaying characters in the input interface for receiving the first language input characters, the input interface positioned in a communication page; and
a target language determination sub-module for using the determined language type as the second language.

18. The apparatus of claim 17, wherein the language setting determination sub-module is configured for:
obtaining one or more machine codes of characters displayed in the communication page; and
applying a Maximum Likelihood Estimate (MLE) to determine a language type that has the largest probability, wherein said language type is used for displaying characters in the input interface for receiving the first language input characters.

19. The apparatus of claim 17, wherein the language setting determination sub-module is configured for:
obtaining one or more attributes of the communication page;
identifying a language from the obtained attributes; and
using the identified language as the language type for displaying characters in the input interface for receiving the first language input characters.

20. The apparatus of claim 17, wherein the language setting determination sub-module is configured for:
using a previously-used second language based on translation records or a user-defined target language as the language type for displaying characters in the input interface for receiving the first language input characters.
